(19) United States
(12) Patent Application Publication
(10) Pub. No.: US 2011/0086758 A1
(43) Pub. Date: Apr. 14, 2011

(54) Fungicidal compositions comprising 3'-bromo-2,3,4,6'-tetramethoxy-2',6-dimethylbenzophenone

(75) Inventors: Markus Gewehr, Kastellaun (DE); Jens Bruns, Neustadt (DE); Maria Scherer, Landau (DE); Egon Haden, Ludwigshafen (DE)

(73) Assignee: BASF SE, Ludwigshafen (DE)

(21) Appl. No.: 12/918,538

(22) PCT Filed: Feb. 20, 2009
(86) PCT No.: PCT/EP2009/052087

§ 371 Date: Dec. 13, 2010

(30) Foreign Application Priority Data
Feb. 22, 2008 (EP) 08151802.9

(51) Int. Cl. A01N 25/00; A01N 43/707; A01P 3/00

(52) U.S. Cl. 504/100; 514/383

(57) ABSTRACT

The present invention relates to a fungicidal compositions comprising 3′-bromo-2,3,4,6′-tetramethoxy-2′,6-dimethylbenzophenone.

The present invention relates to fungicidal compositions comprising, as active components,

active compound 1) 3′-bromo-2,3,4,6′-tetramethoxy-2′,6-dimethylbenzophenone;
and active compound 2), selected from the group consisting of:
2a) 2-(2,4-dichlorophenyl)-1-(1H-[1,2,4]triazol-1-yl)hexan-2-ol;
2b) 1-[[4-bromo-2-(2,4-dichlorophenyl)tetrahydro-2-furanyl]methyl]-1H-1,2,4-triazole; and
2c) 1-{2-[2-chloro-4-(4-chlorophenoxy)phenyl]-4-methyl-[1,3]dioxolan-2-ylmethyl}-1H-[1,2,4]triazole;
   in a synergistically effective amount.

Moreover, the invention relates to a method for controlling harmful fungi using compositions comprising active compound 1) and one of the active compounds 2a), 2b) and 2c), and to the use of active compound 1) with one of the active compounds 2a), 2b) and 2c) for preparing such compositions, and also to agents comprising these mixtures. The invention further relates to the use of the fungicidal mixtures for controlling phytopathogenic fungi and to agents/compositions comprising them.

The above active compound 1), 3′-bromo-2,3,4,6′-tetramethoxy-2′,6-dimethylbenzophenone, is the benzophenone metrafenone, whose preparation and whose action against harmful fungi are known from the literature (EP 0 897 904 A1):

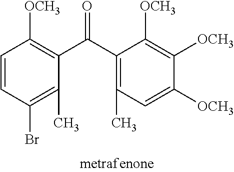

The above active compound 2a), 2-(2,4-dichlorophenyl)-1-(1H-[1,2,4]triazol-1-yl)hexan-2-ol, is the azole hexaconazole, whose preparation and action against harmful fungi are likewise known (CAS RN 79983-71-4).

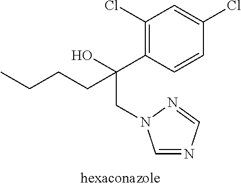

The above active compound 2b), 1-[[4-bromo-2-(2,4-dichlorophenyl)tetrahydro-2-furanyl]methyl]-1H-1,2,4-triazole, is the azole bromuconazole, whose preparation and action against harmful fungi are likewise known (Proc. 1990 Br. Crop. Prot. Conf.—Pests Dis. Vol. 1, p. 459).

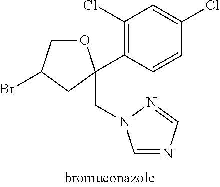

The above active compound 2c), 1-{2-[2-chloro-4-(4-chlorophenoxy)phenyl]-4-methyl-[1,3]dioxolan-2-ylmethyl}-1H-[1,2,4]triazole, is the azole difenoconazole, whose preparation and action against harmful fungi are likewise known (GB-A 2 098 607).

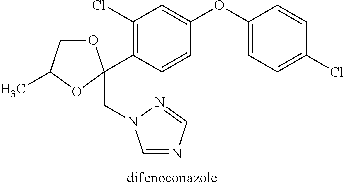

EP 1 023 834 A1 discloses mixtures of benzophenones, such as metrafenone, with a further active compound.

It was an object of the present invention, with a view to reducing the application rates and broadening the activity spectrum of the known compounds, to provide fungicidal compositions which, at a reduced total amount of active compounds applied, have improved activity against harmful fungi, in particular for certain indications.

We have accordingly found the compositions defined at the outset (compositions according to the invention). Moreover, we have found that simultaneous joint or separate application of metrafenone and an active compound 2) or successive application of metrafenone and an active compound 2) allows better control of harmful fungi than is possible with the individual compounds (synergistic mixtures). With regard to lowering the application amounts, these mixtures are of interest since, with a reduced total amount of applied active compounds, many of them exhibit an improved action against harmful fungi, in particular for specific indications. By simultaneous joint or separate application of metrafenone with an active compound 2), the fungicidal activity is increased in a superadditive manner.

The compositions comprising metrafenone and an active compound 2), or the simultaneous joint or simultaneous separate application of metrafenone and an active compound 2), are/is furthermore distinguished by a strengthening and yield-increasing action on plants and excellent activity against a broad spectrum of phytopathogenic fungi, in particular from the classes of the ascomycetes, deuteromycetes, basidiomycetes and peronosporomycetes (syn. oomycetes). Some of them are systemically active and can be used in crop protection as foliar fungicides, as fungicides for seed dressing and as soil fungicides. In addition, they are suitable for controlling fungi which attack inter alia wood or the roots of plants.

They are particularly effective in the control of a large number of fungi on various crop plants, such as bananas, cotton, vegetable plants (for example cucumbers, beans and cucurbits), barley, grass, oats, coffee, potatoes, corn, fruit plants, rice, rye, soybeans, tomatoes, grapevines, wheat, ornamental plants, sugar cane and a large number of seeds, for example in soybeans and rice.

Particular preference is given to the use on crops of grapevines, fruit or vegetables. Particular preference is given to the use on cucurbits, cucumbers, beans, pomaceous fruit, strawberries or cherries.

The compositions comprising metrafenone and an active compound 2) are also used for controlling a large number of fungal pathogens in agricultural crops, for example potatoes, sugar beets, tobacco, wheat, rye, barley, oats, rice, corn, cotton, soybeans, oilseed rape, leguminous plants, sunflowers, coffee or sugarcane; fruit plants, grapevines and ornamental plants and vegetables, for example cucumbers, tomatoes, beans and cucurbits and also on the propagation material, for example seeds, and the harvested products of these plants.

The term “plant propagation materials” includes all generative parts of the plant, for example seeds, and vegetative plant parts, such as seedlings and tubers (for example potatoes) which can be utilized for propagating a plant. These include seeds, roots, fruits, tubers, bulbs, rhizomes, shoots and other plant parts including seedlings and young plants which are transplanted after germination or after emergence. The young plants can be protected by partial or complete treatment, for example by immersion or watering, against harmful fungi.

The treatment of plant propagation materials with compounds I or the compositions according to the invention is used for controlling a large number of fungal pathogens in cereal crops, for example wheat, rye, barley or oats; rice, corn, cotton and soybeans.

The term crop plants also includes those plants which have been modified by breeding, mutagenesis or genetic engineering methods including the biotechnological agricultural products which are on the market or under development (see, for example, http://www.bio.org/speeches/pubs/er/agri_products.asp). Genetically modified plants are plants whose genetic material has been modified in a manner which does not occur under natural conditions by crossing, mutations or by natural recombination (that is a recombination of the genetic information). In general, one or more genes are integrated into the genetic material of the plant in order to improve the properties of the plant. Such modifications by genetic engineering include post-translational modifications of proteins, oligopeptides or polypeptides, for example by glycosylation or attachment of polymers such as, for example, prenylated, acetylated or farnesylated radicals or PEG radicals.

By way of example, mention may be made of plants which, by breeding and genetic engineering, are tolerant to certain classes of herbicides, such as hydroxyphenylpyruvate dioxygenase (HPPD) inhibitors, acetolactate synthase (ALS) inhibitors, such as, for example, sulfonylureas (EP-A 257 993, U.S. Pat. No. 5,013,659) or imidazolinones (for example U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), enolpyruvylshikimate 3-phosphate synthase (EPSPS) inhibitors, such as, for example, glyphosate (see, for example, WO 92/00377), glutamine synthetase (GS) inhibitors, such as, for example, glufosinate (see, for example, EP-A 242 236, EP-A 242 246) or oxynil herbicides (see, for example, U.S. Pat. No. 5,559,024). Clearfield® oilseed rape (BASF SE, Germany), for example, which is tolerant to imidazolinones, for example imazamox, was generated by breeding and mutagenesis. With the aid of genetic engineering methods, crop plants such as soybeans, cotton, corn, beets and oilseed rape were generated which are resistant to glyphosate or glufosinate, and which are obtainable under the trade names RoundupReady® (glyphosate-resistant, Monsanto, U.S.A.) and Liberty Link® (glufosinate-resistant, Bayer CropScience, Germany).

Also included are plants which, owing to interventions by genetic engineering, produce one or more toxins, for example those of the bacterial strain Bacillus. Toxins which are produced by such genetically modified plants include, for example, insecticidal proteins of Bacillus spp., in particular B. thuringiensis, such as the endotoxins Cry1Ab, Cry1Ac, Cry1F, Cry1Fa2, Cry2Ab, Cry3A, Cry3Bb1, Cry9c, Cry34Ab1 or Cry35Ab1; or vegetative insecticidal proteins (VIPs), for example VIP1, VIP2, VIP3, or VIP3A; insecticidal proteins of nematode-colonizing bacteria, for example Photorhabdus spp. or Xenorhabdus spp.; toxins of animal organisms, for example wasp, spider or scorpion toxins; fungal toxins, for example from Streptomyces; plant lectins, for example from peas or barley; agglutinins; protease inhibitors, for example trypsin inhibitors, serine protease inhibitors, patatin, cystatin or papain inhibitors; ribosome-inactivating proteins (RIPs), for example ricin, corn-RIP, abrin, luffin, saporin or bryodin; steroid-metabolizing enzymes, for example 3-hydroxysteroid oxidase, ecdysteroid-IDP glycosyl transferase, cholesterol oxidase, ecdyson inhibitors, or HMG-CoA reductase; ion channel blockers, for example inhibitors of sodium channels or calcium channels; juvenile hormone esterase; receptors of the diuretic hormone (helicokinin receptors); stilbene synthase, bibenzyl synthase, chitinases and glucanases. In the plants, these toxins may also be produced as pretoxins, hybrid proteins or truncated or otherwise modified proteins. Hybrid proteins are characterized by a novel combination of different protein domains (see, for example, WO 2002/015701). Further examples of such toxins or genetically modified plants which produce these toxins are disclosed in EP-A 374 753, WO 93/07278, WO 95/34656, EP-A 427 529, EP-A 451 878, WO 03/18810 and WO 03/52073. The methods for producing these genetically modified plants are known to the person skilled in the art and disclosed, for example, in the publications mentioned above. Many of the toxins mentioned above bestow, upon the plants by which they are produced, tolerance to pests from all taxonomic classes of arthropods, in particular to beetles (Coeleropta), dipterans (Diptera) and butterflies (Lepidoptera) and to nematodes (Nematoda). Genetically modified plants which produce one or more genes coding for insecticidal toxins are described, for example, in the publications mentioned above, and some of them are commercially available, such as, for example, YieldGard® (corn varieties producing the toxin Cry1Ab), YieldGard® Plus (corn varieties which produce the toxins Cry1Ab and Cry3Bb1), Starlink® (corn varieties which produce the toxin Cry9c), Herculex® RW (corn varieties which produce the toxins Cry34Ab1, Cry35Ab1 and the enzyme phosphinothricin-N-acetyltransferase [PAT]); NuCOTN® 33B (cotton varieties which produce the toxin Cry1Ac), Bollgard® I (cotton varieties which produce the toxin Cry1Ac), Bollgard® II (cotton varieties which produce the toxins Cry1Ac and Cry2Ab2); VIPCOT® (cotton varieties which produce a VIP toxin); NewLeaf® (potato varieties which produce the toxin Cry3A); Bt-Xtra®, NatureGard®, KnockOut®, BiteGard®, Protecta®, Bt11 (for example Agrisure® CB) and Bt176 from Syngenta Seeds SAS, France (corn varieties which produce the toxin Cry1Ab and the PAT enzyme), MIR604 from Syngenta Seeds SAS, France (corn varieties which produce a modified version of the toxin Cry3A, see WO 03/018810), MON 863 from Monsanto Europe S.A., Belgium (corn varieties which produce the toxin Cry3Bb1), IPC 531 from Monsanto Europe S.A., Belgium (cotton varieties which produce a modified version of the toxin Cry1Ac) and 1507 from Pioneer Overseas Corporation, Belgium (corn varieties which produce the toxin Cry1F and the PAT enzyme).

Also included are plants which, with the aid of genetic engineering, produce one or more proteins which are more robust or have increased resistance to bacterial, viral or fungal pathogens, such as, for example, pathogenesis-related proteins (PR proteins, see EP-A 0 392 225), resistance proteins (for example potato varieties producing two resistance genes against Phytophthora infestans from the wild Mexican potato Solanum bulbocastanum) or T4 lysozyme (for example potato varieties which, by producing this protein, are resistant to bacteria such as Erwinia amylvora).

Also included are plants whose productivity has been improved with the aid of genetic engineering methods, for example by enhancing the potential yield (for example biomass, grain yield, starch, oil or protein content), tolerance to drought, salt or other limiting environmental factors or resistance to pests and fungal, bacterial and viral pathogens.

Also included are plants whose ingredients have been modified with the aid of genetic engineering methods in particular for improving human or animal diet, for example oil plants producing health-promoting long-chain omega 3 fatty acids or monounsaturated omega 9 fatty acids (for example Nexera® oilseed rape, DOW Agro Sciences, Canada).

Also included are plants which have been modified with the aid of genetic engineering methods for improving the production of raw materials, for example by increasing the amylopectin content of potatoes (Amflora® potato, BASF SE, Germany).

Specifically, the compositions comprising metrafenone and an active compound 2) are suitable for controlling the following plant diseases:

Alternaria species on vegetables, oilseed rape, sugar beet, fruit, rice, soybeans, and also on potatoes (for example A. solani or A. alternata) and tomatoes (for example A. solani or A. alternata) and Alternaria ssp. (black head) on wheat,
Aphanomyces species on sugar beet and vegetables,
Ascochyta species on cereals and vegetables, for example Ascochyta tritici (leaf spot) on wheat,
Bipolaris and Drechslera species on corn, cereals, rice and lawn (for example D. maydis),
Blumeria graminis (powdery mildew) on cereals (for example wheat or barley),
Botrytis cinerea (gray mold) on strawberries, vegetables, flowers, grapevines and wheat (ear mold),
Bremia lactucae on lettuce,
Cercospora species on corn, rice, sugar beet and, for example, Cercospora sojina (leaf blotch) or Cercospora kikuchii (leaf blotch) on soybeans,
Cladosporium herbarum (black head mold) on wheat,
Cochliobolus species on corn, cereals (for example Cochliobolus sativus) and rice (for example Cochliobolus miyabeanus),
Colletotricum species on cotton and, for example, Colletotrichum truncatum (antracnose) on soybeans,
Corynespora cassiicola (leaf blotch) on soybeans,
Dematophora necatrix (root/stem rot) on soybeans,
Diaporthe phaseolorum (stem disease) on soybeans,
Drechslera species, Pyrenophora species on corn, cereals, rice and lawn, on barley (for example D. teres) and on wheat (for example D. tritici-repentis),
Esca on grapevines, caused by Phaeoacremonium chlamydosporium, Ph. Aleophilum, and Formitipora punctata (syn. Phellinus punctatus),
Elsinoe ampelina on grapevines,
Epicoccum spp. (black head mold) on wheat,
Exserohilum species on corn,
Erysiphe cichoracearum and Sphaerotheca fuliginea on cucumbers,
Fusarium and Verticillium species on various plants: for example F. graminearum or F. culmorum (root rot) on cereals (for example wheat or barley) or, for example, F. oxysporum on tomatoes and Fusarium solani (stem disease) on soybeans,
Gaeumanomyces graminis (take-all) on cereals (for example wheat or barley),
Gibberella species on cereals and rice (for example Gibberella fujikuroi),
Glomerella cingulata on grapevines and other plants,
Grainstaining complex on rice,
Guignardia budwelli on grapevines,
Helminthosporium species on corn and rice,
Isariopsis clavispora on grapevines,
Macrophomina phaseolina (root/stem rot) on soybeans,
Michrodochium nivale (pink snow mold) on cereals (for example wheat or barley),
Microsphaera diffusa (powdery mildew) on soybeans,
Mycosphaerella species on cereals, bananas and peanuts, such as, for example, M. graminicola on wheat or M. fijiensis on bananas,
Peronospora species on cabbage (for example P. brassicae), bulbous plants (for example P. destructor) and, for example, Peronospora manshurica (downy mildew) on soybeans,
Phakopsara pachyrhizi (soybean rust) and Phakopsara meibomiae (soybean rust) on soybeans,
Phialophora gregata (stem disease) on soybeans,
Phomopsis species on sunflowers, grapevines (for example P. viticola) and soybeans (for example Phomopsis phaseoli),
Phytophthora species on various plants, for example P. capsici on bell peppers,
Phytophthora megasperma (leaf/stem rot) on soybeans,
Phytophthora infestans on potatoes and tomatoes,
Plasmopara viticola on grapevines,
Podosphaera leucotricha on apples,
Pseudocercosporella herpotrichoides (strawbreaker) on cereals (wheat or barley),
Pseudoperonospora on various plants, for example P. cubensis on cucumbers or P. humili on hops,
Pseudopezicula tracheiphilai on grapevines,
Puccinia species on various plants, for example P. triticina, P. striformins, P. hordei or
P. graminis on cereals (for example wheat or barley) or on asparagus (for example P. asparagi),
Pyricularia oryzae, Corticium sasakii, Sarocladium oryzae, S. attenuatum,
Pyrenophora tritici-repentis (leaf spot) on wheat or Pyrenophora teres (net blotch) on barley,
Entyloma oryzae on rice,
Pyricularia grisea on lawn and cereals,
Pythium spp. on lawn, rice, corn, cotton, oilseed rape, sunflowers, sugar beet, vegetables and other plants (for example P. ultimum or P. aphanidermatum),
Ramularia collo-cygni (physiological leaf spots) on barley,
Rhizoctonia species on cotton, rice, potatoes, lawn, corn, oilseed rape, potatoes, sugar beet, vegetables and on various other plants, for example Rhizoctonia solani (root/stem rot) on soybeans or Rhizoctonia cerealis (yellow patch) on wheat or barley,
Rhynchosporium secalis on barley (scald), rye and triticale,
Sclerotinia species on oilseed rape, sunflowers and, for example, Sclerotinia sclerotiorum (stem disease) or Sclerotinia rolfsii (stem disease) on soybeans,
Septoria glycines (brown spot) on soybeans,
Septoria tritici (leaf spot) and Stagonospora nodorum on wheat,
Erysiphe (syn. Uncinula) necator on grapevines,
Setospaeria species on corn and lawn,
Sphacelotheca reilinia on corn,
Stagonospora nodorum (glume blotch) on wheat,
Thievaliopsis species on soybeans and cotton,
Tilletia species on cereals,
Typhula incarnata (snow mold) on wheat or barley,
Ustilago species on cereals, corn (for example U. maydis) and sugar cane,
Venturia species (scab) on apples (for example V. inaequalis) and pears.

The compositions comprising metrafenone and an active compound 2) are specifically useful for controlling the following plant diseases:

Albugo spp. (white rust) on ornamental plants, vegetable crops (for example A. candida) and sunflowers (for example A. tragopogonis),

Alternaria spp. (black spot disease, black blotch) on vegetables, oilseed rape (for example A. brassicola or A. brassicae), sugar beet (for example A. tenuis), fruit, rice, soybeans and also on potatoes (for example A. solani or A. alternata) and tomatoes (for example A. solani or A. alternata) and Alternaria spp. (black head) on wheat,
Aphanomyces spp. on sugar beet and vegetables,
Ascochyta spp. on cereals and vegetables, for example A. tritici (Ascochyta leaf blight) on wheat and A. hordei on barley,
Bipolaris and Drechslera spp. (teleomorph: Cochliobolus spp.) on corn for example leaf spot (D. maydis and B. zeicola), cereals (for example B. sorokiniana: brown leaf spot), rice (for example B. oryzae) and lawn,
Blumeria (old name: Erysiphe) graminis (powdery mildew) on cereals (for example wheat or barley),
Botryosphaeria spp. (‘Black Dead Arm Disease’) on grapevines (for example B. obtusa),
Botrytis cinerea (teleomorph: Botryotinia fuckeliana: gray mold, gray rot) on soft fruit and pome fruit (inter alia strawberries), vegetables (inter alia lettuce, carrots, celeriac and cabbage), oilseed rape, flowers, grapevines, forest crops and wheat (ear mold),
Bremia lactucae (downy mildew) on lettuce,
Ceratocystis (syn. Ophiostoma) spp. (blue stain fungus) on deciduous trees and coniferous trees, for example C. ulmi (Dutch elm disease) on elms,
Cercospora spp. (Cercospora leaf spot) on corn (for example C. zeae-maydis), rice, sugar beet (for example C. beticola), sugar cane, vegetables, coffee, soybeans (for example C. sojina or C. kikuchii) and rice,
Cladosporium spp. on tomato (for example C. fulvum: tomato leaf mold) and cereals, for example C. herbarum (ear rot) on wheat,
Claviceps purpurea (ergot) on cereals,
Cochliobolus (anamorph: Helminthosporium or Bipolaris) spp. (leaf spot) on corn (for example C. carbonum), cereals (for example C. sativus, anamorph: B. sorokiniana: glume blotch) and rice (for example C. miyabeanus, anamorph: H. oryzae),
Colletotrichum (teleomorph: Glomerella) spp. (anthracnosis) on cotton (for example C. gossypii), corn (for example C. graminicola: stem rot and anthracnosis), soft fruit, potatoes (for example C. coccodes: wilt disease), beans (for example C. lindemuthianum) and on soybeans (for example C. truncatum),
Corticium spp., for example C. sasakii (sheath blight) on rice,
Corynespora cassiicola (leaf spot) on soybeans and ornamental plants,
Cycloconium spp., for example C. oleaginum on olive,
Cylindrocarpon spp. (for example fruit tree cancer or black foot disease of grapevine, teleomorph: Nectria or Neonectria spp.) on fruit trees, grapevines (for example C. liriodendri, teleomorph: Neonectria liriodendri, black foot disease) and many ornamental trees,
Dematophora (teleomorph: Rosellinia) necatrix (root/stem rot) on soybeans,
Diaporthe spp. for example D. phaseolorum (stem disease) on soybeans,
Drechslera (syn. Helminthosporium, teleomorph: Pyrenophora) spp. on corn, cereals, such as barley (for example D. teres, net blotch) and on wheat (for example D. tritici-repentis: DTR leaf spot), rice and lawn,
esca disease (dieback of grapevine, apoplexia) on grapevines, caused by Formitiporia (syn. Phellinus) punctata, F. mediterranea, Phaeomoniella chlamydospora (old name Phaeoacremonium chlamydosporum), Phaeoacremonium aleophilum and/or Botryosphaeria obtusa,
Elsinoe spp. on pome fruit (E. pyri) and soft fruit (E. veneta: anthracnosis) and also grapevines (E. ampelina: anthracnosis),
Entyloma oryzae (leaf smut) on rice,
Epicoccum spp. (black head) on wheat,
Erysiphe spp. (powdery mildew) on sugar beet (E. betae), vegetables (for example E. pisi), such as cucumber species (for example E. cichoracearum) and cabbage species, such as oilseed rape (for example E. cruciferarum)
Eutypa lata (Eutypa cancer or dieback, anamorph: Cytosporina lata, syn. Libertella blepharis) on fruit trees, grapevines and many ornamental trees,
Exserohilum (syn. Helminthosporium) spp. on corn (for example E. turcicum),
Fusarium (teleomorph: Gibberella) spp. (wilt disease, root and stem rot) on various plants, such as for example F. graminearum or F. culmorum (root rot and silver-top) on cereals (for example wheat or barley), F. oxysporum on tomatoes, F. solani on soybeans and F. verticillioides on corn,
Gaeumannomyces graminis (take-all) on cereals (for example wheat or barley) and corn,
Gibberella spp. on cereals (for example G. zeae) and rice (for example G. fujikuroi: bakanae disease),
Glomerella cingulata on grapevines, pome fruit and other plants and G. gossypii on cotton,
Grainstaining complex on rice,
Guignardia bidwellii (black rot) on grapevines,
Gymnosporangium spp. on Rosaceae and juniper, for example G. sabinae (pear rust) on pears,
Helminthosporium spp. (syn. Drechslera, teleomorph: Cochliobolus) on corn, cereals and rice,
Hemileia spp., for example H. vastatrix (coffee leaf rust) on coffee,
Isariopsis clavispora (syn. Cladosporium vitis) on grapevines,
Macrophomina phaseolina (syn. phaseoli) (root/stem rot) on soybeans and cotton,
Microdochium (syn. Fusarium) nivale (pink snow mold) on cereals (for example wheat or barley),
Microsphaera diffusa (powdery mildew) on soybeans,
Monilinia spp., for example M. laxa, M. fructicola and M. fructigena (blossom and twig blight) on stone fruit and other Rosaceae,
Mycosphaerella spp. on cereals, bananas, soft fruit and peanuts, such as for example M. graminicola (anamorph: Septoria tritici, Septoria leaf blotch) on wheat or M. fijiensis (black sigatoka disease) on bananas,
Peronospora spp. (downy mildew) on cabbage (for example P. brassicae), oilseed rape (for example P. parasitica), bulbous plants (for example P. destructor), tobacco (P. tabacina) and soybeans (for example P. manshurica),
Phakopsora pachyrhizi and P. meibomiae (soybean rust) on soybeans,
Phialophora spp. for example on grapevines (for example P. tracheiphila and P. tetraspora) and soybeans (for example P. gregata: stem disease),
Phoma lingam (root and stem rot) on oilseed rape and cabbage and P. betae (leaf spot) on sugar beet,
Phomopsis spp. on sunflowers, grapevines (for example P. viticola: dead-arm disease) and soybeans (for example stem canker/stem blight: P. phaseoli, teleomorph:
Diaporthe phaseolorum),
Physoderma maydis (brown spot) on corn,
Phytophthora spp. (wilt disease, root, leaf, stem and fruit rot) on various plants, such as on bell peppers and cucumber species (for example P. capsici), soybeans (for example P. megasperma, syn. P. sojae), potatoes and tomatoes (for example P. infestans: late blight and brown rot) and deciduous trees (for example P. ramorum: sudden oak death) Plasmodiophora brassicae (club-root) on cabbage, oilseed rape, radish and other plants,
Plasmopara spp., for example P. viticola (peronospora of grapevines, downy mildew) on grapevines and P. halstedii on sunflowers,
Podosphaera spp. (powdery mildew) on Rosaceae, hops, pome fruit and soft fruit, for example P. leucotricha on apple,
Polymyxa spp., for example on cereals, such as barley and wheat (P. graminis) and sugar beet (P. betae) and the viral diseases transmitted thereby,
Pseudocercosporella herpotrichoides (eyespot/stem break, teleomorph: Tapesia yallundae) on cereals, for example wheat or barley,
Pseudoperonospora (downy mildew) on various plants, for example P. cubensis on cucumber species or P. humili on hops,
Pseudopezicula tracheiphila (angular leaf scorch, anamorph: Phialophora) on grapevines,
Puccinia spp. (rust disease) on various plants, for example P. triticina (brown rust of wheat), P. striiformis (yellow rust), P. hordei (dwarf leaf rust of barley), P. graminis (black rust) or P. recondita (brown rust of rye) on cereals, such as for example wheat, barley or rye, and on asparagus (for example P. asparagi),
Pyrenophora (anamorph: Drechslera) tritici-repentis (speckled leaf blotch) on wheat or P. teres (net blotch) on barley,
Pyricularia spp., for example P. oryzae (teleomorph: Magnaporthe grisea, rice blast) on rice and P. grisea on lawn and cereals,
Pythium spp. (damping-off disease) on lawn, rice, corn, wheat, cotton, oilseed rape, sunflowers, sugar beet, vegetables and other plants (for example P. ultimum or P. aphanidermatum),
Ramularia spp., for example R. collo-cygni (Ramularia leaf and lawn spot/physiological leaf spot) on barley and R. beticola on sugar beet,
Rhizoctonia spp. on cotton, rice, potatoes, lawn, corn, oilseed rape, potatoes, sugar beet, vegetables and on various other plants, for example R. solani (root and stem rot) on soybeans, R. solani (sheath blight) on rice or R. cerealis (sharp eyespot) on wheat or barley,
Rhizopus stolonifer (soft rot) on strawberries, carrots, cabbage and tomato,
Rhynchosporium secalis (leaf spot) on barley, rye and triticale,
Sarocladium oryzae and S. attenuatum (sheath rot) on rice,
Sclerotinia spp. (for example stem or soft rot) on vegetable and field crops, such as oilseed rape, sunflowers (for example Sclerotinia sclerotiorum: stem disease) and soybeans (for example S. rolfsii: stem disease),
Septoria spp. on various plants, for example S. glycines (leaf spot) on soybean, S. tritici (Septoria leaf blotch) on wheat and S. (syn. Stagonospora) nodorum (leaf blotch and glume blotch) on cereals,
Uncinula (syn. Erysiphe) necator (powdery mildew, anamorph: Oidium tuckeri) on grapevines,
Setosphaeria spp. (leaf spot) on corn (for example S. turcicum, syn. Helminthosporium turcicum) and lawn,
Sphacelotheca spp. (head smut) on corn, (for example S. reiliana: kernel smut), millet and sugar cane,
Sphaerotheca fuliginea (powdery mildew) on cucumber species,
Spongospora subterranea (powdery scab) on potatoes and the viral diseases transmitted thereby,
Stagonospora spp. on cereals, for example S. nodorum (leaf blotch and glume blotch, teleomorph: Leptosphaeria [syn. Phaeosphaeria] nodorum) on wheat,
Synchytrium endobioticum on potatoes (potato wart disease),
Taphrina spp., for example T. deformans (curly-leaf disease) on peach and T. pruni (plum-pocket disease) on plums,
Thielaviopsis spp. (black root rot) on tobacco, pome fruit, vegetable crops, soybeans and cotton, for example T. basicola (syn. Chalara elegans),
Tilletia spp. (bunt or stinking smut) on cereals, such as for example T. tritici (syn. T. caries, wheat bunt) and T. controversa (dwarf bunt) on wheat,
Typhula incarnata (gray snow mold) on barley or wheat,
Urocystis spp., for example U. occulta (flag smut) on rye,
Uromyces spp. (rust) on vegetable plants, such as beans (for example U. appendiculatus, syn. U. phaseoli) and sugar beet (for example U. betae),
Ustilago spp. (loose smut) on cereals (for example U. nuda and U. avaenae), corn (for example U. maydis: corn smut) and sugar cane,
Venturia spp. (scab) on apples (for example V. inaequalis) and pears,
and Verticillium spp. (leaf and shoot wilt) on various plants, such as fruit trees and ornamental trees, grapevines, soft fruit, vegetable and field crops, such as for example V. dahliae on strawberries, oilseed rape, potatoes and tomatoes.

The compositions comprising metrafenone and an active compound 2) are furthermore suitable for controlling harmful fungi in the protection of materials and buildings (for example wood, paper, paint dispersions, fibers or fabrics) and in the protection of stored products. In the protection of wood and buildings, particular attention is paid to the following harmful fungi: Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp., additionally in the protection of materials the following yeasts: Candida spp. and Saccharomyces cerevisae.

The compositions according to the invention are particularly effective in the control of harmful plants in special crops, such as, for example, grapevines, fruit and vegetables (see the list above).

The compositions comprising metrafenone and an active compound 2) are suitable for improving plant health. Moreover, the invention relates to a method for improving plant health by treating the plants, the plant propagation material and/or the site at which the plants grow or are intended to grow with an effective amount of the compounds I or the compositions according to the invention.

The term “plant health” comprises states of a plant and/or its harvested material which are determined by various indicators individually or in combination, such as, for example, yield (for example increased biomass and/or increased content of utilizable ingredients), plant vitality (for example increased plant growth and/or greener leaves (“greening effect”)), quality (for example increased content or composition of certain ingredients) and tolerance to biotic and/or abiotic stress. The indicators mentioned here for a state of plant health may occur independently of one another or may influence each other.

Metrafenone and active compound 2) can be applied simultaneously jointly, simultaneously separately or in succession, the order, in the case of separate application, generally not having any effect on the result of the control measures.

Thus, according to the invention, active compound 1) and active compound 2) have to be applied such that active compound 1) and active compound 2) are present at the same time at the site of action (i.e. the plant-damaging fungi to be controlled and their habitat, such as infected plants, plant propagation materials, in particular seed, soils, materials or spaces or the plants, plant propagation materials, in particular seed, soils, materials or spaces to be protected against fungal attack) in an amount sufficient for an effective control of fungal growth. This can be achieved by applying active compound 1) and active compound 2) jointly in a joint active compound preparation or simultaneously in at least two separate active compound preparations, or by applying the active compounds successively at the site of action, the interval between the individual active compound applications being chosen such that the active compound applied first is, at the time of the application of the further active compound(s), present in a sufficient amount at the site of action. The order in which the active compounds are applied is of minor importance.

In the compositions according to the invention, the weight ratio of metrafenone to active compound 2) is usually in the range of from 1:100 to 100:1, frequently in the range of from 1:50 to 50:1, preferably in the range of from 1:20 to 20:1, in particular in the range of from 1:10 to 10:1, in particular in the range of from 1:3 to 3:1.

The components of the compositions according to the invention may be packaged and used individually or as a ready mix or as a kit of parts.

In one embodiment of the invention, the kits may comprise one or more, including all, of the components which can be used for preparing an agrochemical composition according to the invention. These kits may comprise, for example, one or more fungicide components and/or an adjuvant component and/or a growth regulator component and/or a herbicide. One or more components may be present combined or preformulated with one another. In the embodiments where more than two components are provided in a kit, the components can be combined with one another and be present packaged in a single container, such as a vessel, bottle, can, bag, sack or canister. In other embodiments, two or more components of a kit may be packaged separately, i.e. not preformulated or mixed. Kits may comprise one or more separate containers, such as vessels, bottles, cans, bags, sacks or canisters, each container comprising a separate component of the agrochemical composition. The components of the composition according to the invention may be packaged and used individually or as a ready mix or as a kit of parts. In both forms, a component may be used separately or together with the other components or as an ingredient of a kit of parts according to the invention for preparing the mixture according to the invention.

The user uses the composition according to the invention usually for use in a predosage device, a knapsack sprayer, a spray tank or a spray plane. Here, the agrochemical composition is diluted with water and/or buffer to the desired application concentration, with further auxiliaries being added, if appropriate, thus giving the ready-to-use spray liquor or the agrochemical composition according to the invention. Usually, from 50 to 500 liters of the ready-to-use spray liquor are applied per hectare of agriculturally utilized area, preferably from 100 to 400 liters.

According to one embodiment, the user may himself mix individual components, such as, for example, parts of a kit or a two- or three-component mixture of the composition according to the invention in a spray tank and, if appropriate, add further auxiliaries (tank mix).

In a further embodiment, the user may mix both individual components of the composition according to the invention and partially pre-mixed components in a spray tank and, if appropriate, add further auxiliaries (tank mix).

In a further embodiment, the user may use both individual components of the composition according to the invention and partially pre-mixed components, jointly (for example as a tank mix) or in succession.

In certain cases, it may be advantageous to add one or more further active compounds to the compositions according to the invention and fungicides or active compounds 1) and 2). These compositions are a particular embodiment of the compositions according to the invention.

Such further active compounds in the above sense are preferably selected from the list below:
A) strobilurins:
   azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-(2-(6-(3-chloro-2-methylphenoxy)-5-fluoropyrimidin-4-yloxy)phenyl)-2-methoxyimino-N-methylacetamide, methyl 2-(ortho-((2,5-dimethylphenyloxy-methylene)phenyl)-3-methoxyacrylate, methyl 3-methoxy-2-(2-(N-(4-methoxyphenyl)-cyclopropanecarboximidoylsulfanylmethyl)phenyl)acrylate, 2-(2-(3-(2,6-dichloro-phenyl)-1-methylallylideneaminooxymethyl)phenyl)-2-methoxyimino-N-methyl-acetamide;
B) carboxamides:
   carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penthiopyrad, sedaxane, tecloftalam, thifiuzamide, tiadinil, 2-amino-4-methylthiazole-5-carboxanilide, 2-chloro-N-(1,1,3-trimethylindan-4-yl)nicotinamide, N-(2′,4′-difluorobiphenyl-2-yl)-3-difluoromethyl-1-methyl-1H-pyrazole-4-carboxamide, N-(2′,4′-dichlorobiphenyl-2-yl)-3-difluoromethyl-1-methyl-1H-pyrazole-4-carboxamide, N-(2′,5′-difluorobiphenyl-2-yl)-3-difluoromethyl-1-methyl-1H-pyrazole-4-carboxamide, N-(2′,5′-dichlorobiphenyl-2-yl)-3-difluoromethyl-1-methyl-1H-pyrazole-4-carboxamide, N-(3′,5′-difluorobiphenyl-2-yl)-3-difluoromethyl-1-methyl-1H-pyrazole-4-carboxamide, N-(3′,5′-dichlorobiphenyl-2-yl)-3-difluoromethyl-1-methyl-1H-pyrazole-4-carboxamide, N-(3′-fluorobiphenyl-2-yl)-3-difluoromethyl-1-methyl-1H-pyrazole-4-carboxamide, N-(3′-chlorobiphenyl-2-yl)-3-difluoromethyl-1-methyl-1H-pyrazole-4-carboxamide, N-(2′-fluorobiphenyl-2-yl)-3-difluoromethyl-1-methyl-1H-pyrazole-4-carboxamide, N-(2′-chlorobiphenyl-2-yl)-3-difluoromethyl-1-methyl-1H-pyrazole-4-carboxamide, N-(3′,4′,5′-trifluorobiphenyl-2-yl)-3-difluoromethyl-1-methyl-1H-pyrazole-4-carboxamide, N-(2′,4′,5′-trifluorobiphenyl-2-yl)-3-difluoromethyl-1-methyl-1H-pyrazole-4-carboxamide, N-[2-(1,1,2,3,3,3-hexafluoropropoxy)phenyl]-3-difluoromethyl-1-methyl-1H-pyrazole-4-carboxamide, N-[2-(1,1,2,2-tetrafluoroethoxy)phenyl]-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(3′,4′-dichloro-5-fluorobiphenyl-2-yl)-3-difluoromethyl-1-methyl-1H-pyrazole-4-carboxamide, N-(2-(1,3-dimethylbutyl)phenyl)-1,3,3-trimethyl-5-fluoro-1H-pyrazole-4-carboxamide, N-(2-(1,3-dimethylbutyl)phenyl)-1,3-dimethyl-5-fluoro-1H-pyrazole-4-carboxamide, N-(2-(1,3,3-trimethylbutyl)phenyl)-1,3-dimethyl-5-fluoro-1H-pyrazole-4-carboxamide, N-(4′-chloro-3′,5′-difluorobiphenyl-2-yl)-3-difluoromethyl-1-methyl-1H-pyrazole-4-carboxamide, N-(4′-chloro-3′,5′-difluorobiphenyl-2-yl)-3-trifluoromethyl-1-methyl-1H-pyrazole-4-carboxamide, N-(3′,4′-dichloro-5′-fluorobiphenyl-2-yl)-3-trifluoromethyl-1-methyl-1H-pyrazole-4-carboxamide, N-(3′,5′-difluoro-4′-methylbiphenyl-2-yl)-3-difluoromethyl-1-methyl-1H-pyrazole-4-carboxamide, N-(3′,5′-difluoro-4′-methylbiphenyl-2-yl)-3-trifluoromethyl-1-methyl-1H-pyrazole-4-carboxamide, N-(2-bicyclopropyl-2-ylphenyl)-3-difluoromethyl-1-methyl-1H-pyrazole-4-carboxamide, N-(cis-2-bicyclopropyl-2-ylphenyl)-3-difluoromethyl-1-methyl-1H-pyrazole-4-carboxamide, N-(trans-2-bicyclopropyl-2-ylphenyl)-3-difluoromethyl-1-methyl-1H-pyrazole-4-carboxamide;
   carboxylic acid morpholides: dimethomorph, flumorph, pyrimorph;
   benzamides: flumetover, fluopicolide, fluopyram, zoxamide, N-(3-ethyl-3,5,5-tri-methylcyclohexyl)-3-formylamino-2-hydroxybenzamide;
   other carboxamides: carpropamid, diclocymet, mandipropamid, oxytetracyclin, silthiofam, N-(6-methoxypyridin-3-yl)cyclopropanecarboxamide;
C) azoles:
   triazoles: azaconazole, bitertanole, cyproconazole, diniconazole, diniconazole-M, epoxiconazole, fenbuconazole, fiuquinconazole, flusilazole, flutriafole, imibenconazole, ipconazole, metconazole, myciobutanil, oxpoconazole, paclobutrazole, penconazole, propiconazole, prothioconazole, simeconazole, tebuconazole, tetraconazole, triadimefon, triadimenole, triticonazole, uniconazole, 1-(4-chlorophenyl)-2-([1,2,4]triazol-1-yl)cycloheptanol;
   imidazoles: cyazofamid, imazalil, imazalil sulfate, pefurazoate, prochloraz, triflumizole;
   benzimidazoles: benomyl, carbendazim, fuberidazole, thiabendazole;
   others: ethaboxam, etridiazole, hymexazol, 1-(4-chlorophenyl)-1-(propyn-2-yloxy)-3-(4-(3,4-dimethoxyphenyl)isoxazol-5-yl)propan-2-one, 2-(4-chlorophenyl)-N-[4-(3,4-dimethoxyphenyl)isoxazol-5-yl]-2-prop-2-ynyloxyacetamide;
D) nitrogenous heterocyclyl compounds
   pyridines: fluazinam, pyrifenox, 3-[5-(4-chlorophenyl)-2,3-dimethylisoxazolidin-3-yl]-pyridine, 3-[5-(4-methylphenyl)-2,3-dimethylisoxazolidin-3-yl]pyridine, 2,3,5,6-tetra-chloro-4-methanesulfonylpyridine, 3,4,5-trichloropyridine-2,6-dicarbonitrile, N-(1-(5-bromo-3-chloropyridin-2-yl)ethyl)-2,4-dichloronicotinamide, N-((5-bromo-3-chloropyridin-2-yl)methyl)-2,4-dichloronicotinamide;
   pyrimidines: bupirimate, cyprodinil, diflumetorim, fenarimol, ferimzone, mepanipyrim, nitrapyrin, nuarimol, pyrimethanil;
   piperazines: triforine;
   pyrroles: fludioxonil, fenpiclonil;
   morpholines: aldimorph, dodemorph, dodemorph acetate, fenpropimorph, tridemorph;
   piperidines: fenpropidin;
   dicarboximides: fluoroimide, iprodione, procymidone, vinclozolin;
   nonaromatic 5-membered heterocycles: famoxadone, fenamidone, flutianil, octhilinone, probenazole, S-allyl 5-amino-2-isopropyl-3-oxo-4-ortho-tolyl-2,3-dihydropyrazole-1-thiocarboxylate;
   others: acibenzolar-S-methyl, amisulbrom, anilazine, blasticidin-S, captafol, captan, quinomethionate, dazomet, debacarb, diclomezine, difenzoquat, difenzoquat methylsulfate, fenoxanil, folpet, oxolinic acid, piperalin, proquinazid, pyroquilone, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzimidazole, N-(4-(3-methoxy-1-(5-methyl-[1,2,3]thiadiazol-4-yl)naphthalen-2-yl)thiazol-2-yl)butyramide, 5-chloro-7-(4-methylpiperidin-1-yl)-6-(2,4,6-trifluorophenyl)-[1,2,4]triazolo[1,5-a]-pyrimidine, 6-(3,4-dichlorophenyl)-5-methyl-[1,2,4]triazolo[1,5-a]pyrimidin-7-ylamine, 6-(4-tert-butylphenyl)-5-methyl-[1,2,4]triazolo[1,5-a]pyrimidin-7-ylamine, 5-methyl-6-(3,5,5-trimethylhexyl)-([1,2,4]triazolo[1,5-a]pyrimidin-7-ylamine, 5-methyl-6-octyl-[1,2,4]triazolo[1,5-a]pyrimidin-7-ylamine, 6-methyl-5-octyl-[1,2,4]triazolo[1,5-a]-pyrimidin-7-ylamine, 6-ethyl-5-octyl-[1,2,4]triazolo[1,5-a]pyrimidin-7-ylamine, 5-ethyl-6-octyl-[1,2,4]-triazolo[1,5-a]pyrimidin-7-ylamine, 5-ethyl-6-(3,5,5-trimethylhexyl)-[1,2,4]triazolo[1,5-a]pyrimidin-7-ylamine, 6-octyl-5-propyl-[1,2,4]triazolo[1,5-a]-pyrimidin-7-ylamine, 5-methoxymethyl-6-octyl-[1,2,4]triazolo[1,5-a]pyrimidin-7-ylamine, 6-octyl-5-trifluoromethyl-[1,2,4]triazolo[1,5-a]pyrimidin-7-ylamine and 5-trifluoromethyl-6-(3,5,5-trimethylhexyl)-[1,2,4]triazolo[1,5-a]pyrimidin-7-ylamine;
E) carbamates and dithiocarbamates
   thio- and dithiocarbamates: ferbam, mancozeb, maneb, metam, methasulfocarb, metiram, propineb, thiram, zineb, ziram;
   carbamates: diethofencarb, benthiavalicarb, iprovalicarb, propamocarb, propamocarb hydrochloride, valiphenal, 4-fluorophenyl N-(1-(1-(4-cyanophenyl)ethanesulfonyl)but-2-yl)carbamate;
F) other fungicides
   guanidines: dodine, dodine free base, guazatine, guazatine acetate, iminoctadine, iminoctadine triacetate, iminoctadine tris(albesilate);
   antibiotics: kasugamycin, kasugamycin hydrochloride hydrate, polyoxins, streptomycin, validamycin A;
   nitrophenyl derivatives: binapacryl, dicloran, dinobuton, dinocap, nitrothal isopropyl, tecnazene;
   organometallic compounds: fentin salts, such as, for example, fentin acetate, fentin chloride, fentin hydroxide;
   sulfur-containing heterocyclyl compounds: dithianon, isoprothiolane;
   organophosphorus compounds: edifenphos, fosetyl, fosetyl aluminum, iprobenfos, phosphorous acid and its salts, pyrazophos, tolclofos-methyl;
   organochlorine compounds: chlorothalonil, dichiofluanid, dichlorophen, flusulfamide, hexachlorobenzene, pencycuron, pentachlorophenol and its salts, phthalide, quintozene, thiophanate methyl, tolylfluanid, N-(4-chloro-2-nitrophenyl)-N-ethyl-4-methylbenzenesulfonamide;
   inorganic active compounds: phosphorous acid and its salts, Bordeaux mixture, copper salts, such as, for example, copper acetate, copper hydroxide, copper oxy-chloride, basic copper sulfate, sulfur;
   others: biphenyl, bronopol, cyflufenamid, cymoxanil, diphenylamine, mildiomycin, oxine-copper, prohexadione-calcium, spiroxamine, tolylfluanid, N-(cyclopropyl-methoxyimino-(6-difluoromethoxy-2,3-difluorophenyl)methyl)-2-phenylacetamide, N′-(4-(4-chloro-3-trifluoromethylphenoxy)-2,5-dimethylphenyl)-N-ethyl-N-methyl-formamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)-phenyl)-N-ethyl-N-methylformamidine, N′-(5-difluoromethyl-2-methyl-4-(3-trimethyl-silanylpropoxy)phenyl)-N-ethyl-N-methylformamidine, 2-{1-[2-(5-methyl-3-trifluoromethylpyrazol-1-yl)acetyl]piperidin-4-yl}thiazole-4-carboxylic methyl-(1,2,3,4-tetrahydronaphthalen-1-yl)amide, 2-{1-[2-(5-methyl-3-trifluoromethylpyrazol-1-yl)acetyl]piperidin-4-yl}thiazole-4-carboxylic methyl-(R)-1,2,3,4-tetrahydronaphthalen-1-yl-amide, 6-tert-butyl-8-fluoro-2,3-dimethylquinolin-4-ylacetate, 6-tert-butyl-8-fluoro-2,3-dimethylquinolin-4-yl methoxy acetate;
G) growth regulators
   abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidide, mepiquat (mepiquat chloride), metconazole, naphthalene acetic acid, N-6-benzyladenine, paclobutrazole, prohexadione (prohexadione-calcium), prohydrojasmon, thidiazuron, triapenthenol, tributyl phosphorotrithioate, 2,3,5-triiodobenzoic acid, trinexapac-ethyl and uniconazole;
H) herbicides
   acetamides: acetochlor, alachlor, butachlor, dimethachlor, dimethenamid, dimethenamid-P, flufenacet, mefenacet, metolachlor, metazachlor, napropamide, naproanilide, pethoxamid, pretilachlor, propachlor, thenylchlor;
   amino acid analogues: bilanafos, glyphosate, glufosinate, sulfosate;
   aryloxyphenoxypropionates: clodinafop, cyhalofop-butyl, fenoxaprop, fluazifop, haloxyfop, metamifop, propaquizafop, quizalofop, quizalofop-p-tefuryl;
   bipyridyls: diquat, paraquat;
   carbamates and thiocarbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
   cyclohexanediones: butroxydim, clethodim, cycloxydim, profoxydim, sethoxydim, tepraloxydim, tralkoxydim;
   dinitroanilines: benfluralin, ethalfiuralin, oryzalin, pendimethalin, prodiamine, trifiuralin;
   diphenyl ethers: acifluorfen, aclonifen, bifenox, diclofop, ethoxyfen, fomesafen, lactofen, oxyfluorfen;
   hydroxybenzonitriles: bromoxynil, dichiobenil, ioxynil;
   imidazolinones: imazamethabenz, imazamox, imazapic, imazapyr, imazaquin, imazethapyr;
   phenoxyacetic acids: clomeprop, 2,4-dichlorophenoxyacetic acid (2,4-D), 2,4-DB, dichlorprop, MCPA, MCPA-thioethyl, MCPB, mecoprop;
   pyrazines: chloridazone, flufenpyr-ethyl, fluthiacet, norflurazone, pyridate;
   pyridines: aminopyralid, clopyralid, diflufenican, dithiopyr, fluridone, fluoroxypyr, picloram, picolinafen, thiazopyr;
   sulfonylureas: amidosulfuron, azimsulfuron, bensulfuron, chlorimuron-ethyl, chiorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxypyrimidin-2-yl)urea;
   triazines: ametryn, atrazine, cyanazine, dimethametryn, ethiozine, hexazinone, metamitron, metribuzin, prometryn, simazine, terbuthylazine, terbutryn, triaziflam;
   ureas: chlorotoluron, daimuron, diuron, fluometuron, isoproturon, linuron, methabenzthiazuron, tebuthiuron;
   other inhibitors of acetolactate synthase: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone, pyroxsulam;
   others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethlyl, chlorethoxyfos, chlorpyrifos, chlorthal, cinmethylin, clomazone, cumyluron, cyprosulfamide, dicamba, difenzoquat, diflufenzopyr, diofenolan, Drechslera monoceras, endothal, ethofumesate, etobenzanid, fentrazamide, flumiclorac-pentyl, flumioxazin, flupoxam, fluorochloridone, flurtamone, indanofan, isoxaben, isoxaflutole, lenacil, propanil, propyzamide, quinclorac, quinmerac, mesotrione, methylarsenic acid, naptalam, oxadiargyl, oxadiazon, oxaziclomefone, pentoxazone, phenoxycarb, pinoxaden, pymetrozine, pyraclonil, pyraflufen-ethyl, pyrasulfotol, pyrazoxyfen, pyrazolynate, quinoclamine, saflufenacil, sulcotrion, sulfentrazone, tebupirimfos, terbacil, tefluthrin, tefuryltrione, tembotrione, terbufos, thiencarbazone, topramezone, 4-hydroxy-3-[2-(2-methoxyethoxymethyl)-6-trifluoromethylpyridine-3-carbonyl]bicyclo[3.2.1]oct-3-ene-2-one, ethyl(3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclopropylpyrimidine-4-carboxylate, 6-chloro-3-(2-cyclopropyl-6-methylphenoxy)pyridazin-4-ol, 4-amino-3-chloro-6-(4-chlorophenyl)-5-fluoropyridine-2-carboxylic acid, methyl 4-amino-3-chloro-6-(4-chloro-2-fluoro-3-methoxyphenyl)pyridine-2-carboxylate and methyl 4-amino-3-chloro-6-(4-chloro-3-dimethylamino-2-fluorophenyl)pyridine-2-carboxylate;

The active compounds mentioned above, their preparation and their action against harmful fungi are known (cf.: http://www.hclrss.demon.co.uk/index.html; http://www.alanwood.net/pesticides/); they are commercially available. The compounds named according to IUPAC, their preparation and their fungicidal action are likewise known (cf. EP-A 141 317, EP-A 226 917; EP-A 1 028 125; EP-A 1 035 122; EP-A 1 201 648; WO 98/46608; WO 99/24413; WO 03/14103; WO 03/53145; WO 03/66609; WO 04/49804; WO 05/87772; WO 05/87773; WO 06/087325), Can. J. Plant Sci. 48(6), 587-94, 1968; EP-A 152 031; EP-A 243 970; EP-A 256 503; EP-A 428 941; EP-A 532 022; EP-A 1 122 244, JP 2002316902; DE 19650197; DE 10021412; DE 102005009458; U.S. Pat. No. 3,296,272; U.S. Pat. No. 3,325,503; WO 99/14187; WO 99/24413; W 99/27783; WO 00/29404; WO 00/46148; WO 00/65913; WO 01/54501; WO 01/56358; WO 02/22583; WO 02/40431; WO 03/10149; WO 03/11853; WO 03/16286; WO 03/61388; WO 03/74491; WO 05/120234; WO 05/123689; WO 05/123690; WO 05/63721; WO 06/15866; WO 06/87343; WO 07/82098; WO 07/90624).

The present compositions of mixtures of two or more active compounds are prepared in a known manner in the form of compositions comprising, in addition to the active compounds, a solvent or a solid carrier, for example in the manner stated above for the present compositions comprising metrafenone and an active compound 2). With respect to the customary ingredients of such compositions, reference is made to what was said about the compositions above.

The present invention therefore also provides fungicidal compositions comprising active compound and at least one active compound 2 and at least one further active compound, for example one or more e.g., 1 or 2, active compounds of the aforementioned A to H and, if appropriate, one or more agriculturally suitable carriers.

Preferred ternary compositions of the invention are the following which, accordingly, are preferably present in fungicidal compositions according to the invention:

T1 metrafenone, hexaconazole and azoxystrobin.
T2 metrafenone, hexaconazole and boscalid.
T3 metrafenone, hexaconazole and cyflufenamid.
T4 metrafenone, hexaconazole and cyprodinil.
T5 metrafenone, hexaconazole and dimethomorph.
T6 metrafenone, hexaconazole and dithianone.
T7 metrafenone, hexaconazole and iprodione.
T8 metrafenone, hexaconazole and kresoxim-methyl.
T9 metrafenone, hexaconazole and proquinazid.
T10 metrafenone, hexaconazole and pyraclostrobin.
T11 metrafenone, hexaconazole and pyrimethanil.
T12 metrafenone, hexaconazole and quinoxyfen.
T13 metrafenone, hexaconazole and trifloxystrobin.
and also
T14 metrafenone, difenoconazole and azoxystrobin.
T15 metrafenone, difenoconazole and boscalid.
T16 metrafenone, difenoconazole and cyflufenamid.
T17 metrafenone, difenoconazole and cyprodinil.
T18 metrafenone, difenoconazole and dimethomorph.
T19 metrafenone, difenoconazole and dithianon.
T20 metrafenone, difenoconazole and iprodione.
T21 metrafenone, difenoconazole and kresoxim-methyl.
T22 metrafenone, difenoconazole and proquinazid.
T23 metrafenone, difenoconazole and pyraclostrobin.
T24 metrafenone, difenoconazole and pyrimethanil.
T25 metrafenone, difenoconazole and quinoxyfen.
T26 metrafenone, difenoconazole and trifloxystrobin.

Where the components of the ternary compositions are in each case present in synergistic amounts.

In the ternary mixtures, the weight ratio of metrafenone to the third active compound is preferably in the range of from 1:50 to 50:1, in particular in the range of from 1:10 to 10:1. The weight ratio of active compound 2) to the third active compound is preferably in the range of from 1:50 to 50:1, in particular in the range of from 1:10 to 10:1. The weight ratio of metrafenone to active compound 2) is preferably as indicated above.

The active compounds can also be used in the form of their agriculturally compatible salts. These are usually alkali metal or alkaline earth metal salts, such as sodium salts, potassium salts or calcium salts.

Depending on the type of compound and the desired effect, the application rates of the compositions according to the invention are from 5 g/ha to 2000 g/ha, preferably from 50 to 900 g/ha, in particular from 50 to 750 g/ha.

Correspondingly, the application rates for metrafenone are generally from 1 to 1000 g/ha, preferably from 10 to 900 g/ha, in particular from 20 to 750 g/ha.

Correspondingly, the application rates for the active compound 2) are generally from 1 to 2000 g/ha, preferably from 10 to 900 g/ha, in particular from 40 to 500 g/ha.

In the treatment of plant propagation material, for example seed treatment, for example by dusting, coating or soaking seeds, application rates of composition according to the invention are generally from 0.1 to 1000 g/100 kg of propagation material or seed, preferably from 1 to 1000 g/100 kg of seed, particularly preferably from 1 to 750 g/100 kg, in particular from 5 to 500 g/100 kg and in particular from 5 to 100 g/100 kg.

When used in the protection of materials and stored products, the application rate of active compound or composition according to the invention depends on the type of application and the desired effect. In the protection of materials, for example, customary application rates are from 0.001 g to 2 kg, preferably from 0.005 g to 1 kg, of active compound per cubic meter of material treated.

The method for controlling harmful fungi is carried out by the separate or joint application of metrafenone and the active compound 2) or the compositions of metrafenone and the active compound 2) by spraying or dusting the seeds, the plants or the soils before or after sowing of the plants or before or after emergence of the plants.

Metrafenone and the active compound 2) or mixtures thereof are employed as such or in the form of a composition by treating the harmful fungi, their habitat or the plants or plant propagation materials, for example seed materials to be protected against fungal attack, the soil, areas, materials or spaces with a fungicidally effective amount of the active compounds. The application can be carried out both before and after the infection of the plants, plant propagation materials, for example seed materials, the soil, the areas, materials or spaces by the fungi.

Plant propagation materials can be treated prophylactically during or even before sowing or during or even before transplanting with the inventive compositions.

The invention furthermore relates to agrochemical compositions comprising a solvent or solid carrier and metrafenone compound and an active compound 2), for controlling harmful fungi.

An agrochemical composition comprises a fungicidally effective amount of the active compounds. The term “effective amount” refers to an amount of the agrochemical composition or of the active compounds which is sufficient for controlling harmful fungi on crop plants or in the protection of materials and buildings and does not cause any significant damage to the treated crop plants. Such an amount may vary within a wide range and is influenced by numerous factors, such as, for example, the harmful fungus to be controlled, the respective crop plant or materials treated, the climatic conditions and compounds.

The compositions according to the invention, or metrafenone and the active compound 2) can be converted into the customary formulations (agrochemical compositions), for example solutions, emulsions, suspensions, dusts, powders, pastes and granules. The use form or the type of composition depends on the particular intended purpose; in each case, it should ensure a fine and even distribution of the composition according to the invention.

The term “agent” herein is used interchangeably with the term “composition”, in particular “agrochemical composition”, and “formulation”.

The invention therefore also provides a fungicidal agent comprising a liquid or solid carrier material and a composition according to the invention.

Examples of types of compositions are suspensions (SC, OD, FS), pastes, pastilles, wettable powders or dusts (WP, SP, SS, WS, DP, DS) or granules (GR, FG, GG, MG) which may either be water-soluble or dispersible (wettable), and also gels for treating plant propagation materials such as seed (GF).

In general, the composition types (for example SC, OD, FS, WG, SG, WP, SP, SS, WS, GF) are used in diluted form. Composition types such as DP, DS, GR, FG, GG and MG are generally employed in undiluted form.

The formulations (agrochemical compositions) are prepared in a known manner, for example by extending the active compound with solvents and/or carriers, if desired using emulsifiers and dispersants (see, for example, U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th edition, McGraw-Hill, New York, 1963, 8-57 and ff., WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (John Wiley & Sons, New York, 1961), Hance et al.: Weed Control Handbook (8th Ed., Blackwell Scientific Publications, Oxford, 1989) and Mollet, H. and Grubemann, A.: Formulation Technology (Wiley VCH Verlag, Weinheim, 2001). The agrochemical compositions may furthermore also comprise auxiliaries customary for crop protection compositions, the selection of the auxiliaries depending on the use form or the active compound in question.

Examples of suitable auxiliaries are solvents, solid carriers, surfactants (such as further solubilizers, protective colloids, wetting agents and tackifiers), organic and inorganic thickeners, bactericides, antifreeze agents, antifoams, if appropriate colorants and adhesives (for example for the treatment of seed).

Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters, organic solvents such as mineral oil fractions of medium to high boiling point such as kerosene and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, glycols, ketones, such as cyclohexanone, gamma-butyrolactone, dimethyl fatty acid amides, fatty acids and fatty acid esters and highly polar solvents, for example amines such as N-methylpyrrolidone. In principle, solvent mixtures may also be used,
carriers such as ground natural minerals (for example kaolins, clays, talc, chalk) and ground synthetic minerals (for example finely divided silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose, silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers, such as ammonium sulfate, ammonium phosphate, ammonium nitrate, ureas, and products of vegetable origin such as cereal meal, tree bark meal, wood meal and nutshell meal, cellulose powders.

Suitable surfactants (adjuvants, wetters, tackifiers, dispersants or emulsifiers) used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose, in particular lignosulfonic acid (Borresperse® types, Borregaard, Norway), phenolsulfonic acid, naphthalenesulfonic acid (Morwet® types, Akzo Nobel, USA) and dibutylnaphthalenesulfonic acid (Nekal® types, BASF, Germany), and also of fatty acids, alkyl- and alkylarylsulfonates, alkyl, lauryl ether and fatty alcohol sulfates, and also salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octyl phenol ether, ethoxylated isooctylphenol, octylphenol or nonylphenol, alkylphenyl polyglycol ether, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfide waste liquors, and also proteins, denatured proteins, polysaccharides (for example methylcellulose), hydrophobically modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinylpyrrolidone and copolymers thereof.

Examples of thickeners (i.e. compounds which impart modified flow properties to the composition, i.e. high viscosity in the state of rest and low viscosity in motion) are polysaccharides and also organic and inorganic sheet minerals, such as xanthan gum (Kelzan®, CP Kelco, USA), Rhodopol° 23 (Rhodia, France) or Veegum® (R.T. Vanderbilt, USA) or Attaclay® (Engelhard Corp., NJ, USA).

Bactericides can be added for stabilizing the composition. Examples of bactericides are bactericides based on dichlorophen and benzyl alcohol hemiformal (Proxel® from ICI or Acticide® RS from Thor Chemie and Kathon® MK from Rohm & Haas), and also isothiazolinone derivatives, such as alkyl isothiazolinones and benzisothiazolinones (Acticide® MBS from Thor Chemie).

Examples of suitable antifreeze agents are ethylene glycol, propylene glycol, urea and glycerol.

Examples of antifoams are silicone emulsions (such as, for example, Silikon® SRE, Wacker, Germany or Rhodorsil®, Rhodia, France), long-chain alcohols, fatty acids, salts of fatty acids, organofluorine compounds and mixtures thereof.

Examples of colorants are both sparingly water-soluble pigments and water-soluble dyes. Examples which may be mentioned are the dyes and pigments known under the names Rhodamin B, C. I. Pigment Red 112 and C. I. Solvent Red 1, Pigment blue 15:4, Pigment blue 15:3, Pigment blue 15:2, Pigment blue 15:1, Pigment blue 80, Pigment yellow 1, Pigment yellow 13, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

Examples of adhesives are polyvinylpyrrolidone, polyvinyl acetate, polyvinyl alcohol and cellulose ether (Tylose®, Shin-Etsu, Japan).

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations (types of composition): 1. Products for dilution with water

### A Water-Soluble Concentrates (SL, LS)

10 parts by weight of the active compounds are dissolved in 90 parts by weight of water or in a water-soluble solvent. As an alternative, wetting agents or other auxiliaries are added. The active compound dissolves upon dilution with water. In this way, a formulation having a content of 10% by weight of active compound is obtained.

### B Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight

### C Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

### D Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The formulation has an active compound content of 25% by weight.

### E Suspensions (SC, OD, FS)

In an agitated ball mill, 20 parts by weight of the active compounds are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

### F Water-Dispersible Granules and Water-Soluble Granules (WG, SG)

50 parts by weight of the active compounds are ground finely with addition of 50 parts by weight of dispersants and wetting agents and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

### G Water-Dispersible Powders and Water-Soluble Powders (WP, SP, SS, WS)

75 parts by weight of the active compounds are ground in a rotor-stator mill with addition of 25 parts by weight of dispersants, wetters and silica gel. Dilution with water gives a stable dispersion or solution of the active compound. The active compound content of the formulation is 75% by weight.

### H Gel Formulations (GF)

In a ball mill, 20 parts by weight of the active compounds, 10 parts by weight of dispersant, 1 part by weight of gelling agent and 70 parts by weight of water or an organic solvent are ground to give a fine suspension. On dilution with water, a stable suspension having an active compound content of 20% by weight is obtained.

### 2. Products to be Applied Undiluted

### I Dustable Powders (DP, DS)

5 parts by weight of the active compounds are ground finely and mixed intimately with 95 parts by weight of finely divided kaolin. This gives a dustable product having an active compound content of 5% by weight.

### Granules (GR, FG, GG, MG)

0.5 part by weight of the active compounds is ground finely and associated with 99.5 parts by weight of carriers. Current methods are extrusion, spray-drying or the fluidized bed. This gives granules to be applied undiluted having an active compound content of 0.5% by weight.

### K ULV Solutions (UL)

10 parts by weight of the active compounds are dissolved in 90 parts by weight of an organic solvent, for example xylene. This gives a product to be applied undiluted having an active compound content of 10% by weight.

For the treatment of plant propagation material, in particular seed treatment, use is usually made of water-soluble concentrates (LS), suspensions (FS), dustable powders (DS), water-dispersible and water-soluble powders (WS, SS), emulsions (ES), emulsifiable concentrates (EC) and gel formulations (GF). These formulations can be applied to the seed in undiluted form or, preferably, diluted: In this case, the corresponding composition can be diluted 2 to 10 times so that in the compositions to used for the seed dressing from 0.01 to 60% by weight, preferably from 0.1 to 40% by weight of active compound are present. The application can be carried out before or during sowing, preferably before sowing.

The treatment of plant propagation material, in particular the treatment of seed, is known to the person skilled in the art and is carried out by dusting, coating, pelleting, dipping or drenching the plant propagation material, the treatment preferably being carried out by pelleting, coating and dusting or by furrow treatment, such that, for example, premature germination of the seed is prevented.

For seed treatment, preference is given to using suspensions. Such compositions usually comprise from 1 to 800 g of active compound/I, from 1 to 200 g of surfactants/l, from 0 to 200 g of antifreeze agent/I, from 0 to 400 g of binders/l, from 0 to 200 g of colorants/l and solvents, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (wettable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, welters, adjuvants, herbicides, fungicides, other pesticides, or bactericides may be added to the active compounds or the compositions comprising them, even, if appropriate, not until immediately prior to use (tank mix). These agents may be admixed with the compositions according to the invention in a weight ratio of from 1:100 to 100:1, preferably from 1:10 to 10:1.

The following are particularly suitable as adjuvants in this context: organically modified polysiloxanes, for example Break Thru S 240®; alcohol alkoxylates, for example Atplus 245®, Atplus MBA 1303®, Plurafac LF 300® and Lutensol ON 30®; EO-PO block polymers, for example Pluronic RPE 2035® and Genapol B®; alcohol ethoxylates, for example Lutensol XP 80®; and sodium dioctylsulfosuccinate, for example Leophen RA®.

### Use Examples

The fungicidal activity of the compositions and mixtures according to the invention was demonstrated by the following tests:

The active compounds, separately or jointly, were prepared as a stock solution comprising 25 mg of active compound which was made up to 10 ml using a mixture of acetone and/or DMSO and the emulsifier Uniperol® EL (wetting agent having an emulsifying and dispersing action based on ethoxylated alkylphenols) in a ratio by volume of solvent/emulsifier of 99:1. The mixture was then made up to 100 ml with water. This stock solution was diluted with the solvent/emulsifier/water mixture described to give the concentration of active compound stated below.

The visually determined percentages of infected leaf areas were converted into efficacies in % of the untreated control:

The efficacy (E) is calculated as follows using Abbot's formula:

W=(1−α/β)·100
α corresponds to the fungicidal infection of the treated plants in % and
β corresponds to the fungicidal infection of the untreated (control) plants in %

At an efficacy of 0, the infection level of the treated plants corresponds to that of the untreated control plants; at an efficacy of 100, the treated plants are not infected.

The expected efficacies of active compound mixtures were determined using Colby's formula (S. R. Colby, “Calculating synergistic and antagonistic responses of herbicide combinations”, Weeds 15, pp. 20-22 (1967) and compared with the observed efficacies.

### Colby's Formula:

E=x+y−x·y/100
expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

### Field Testing

The trial was carried out under standardized field conditions. Melons were grown in the field. After 36 days, an application with the recited products was carried out, which was repeated two times after 7 days and after 14 days. No further active components for pathogen control were applied. The infection with the pathogen Sphaerotheca fuliginea ensued naturally. Infestation in % of leaf area affected was scored 35 days after the first application. The visually determined values of % of leaf area infected was initially averaged and then converted into efficacies as % of the untreated control. An efficacy of 0 is the same infestation as the untreated control, an efficacy of 100% is 0% infestation. The expected efficacies of active compound combinations were determined as described above using Colby's formula and compared with the observed efficacies.

The active compounds were used as commercially available compositions. Metrafenone was used as 550 g/L metrafenone SC (suspension concentrate) formulation (Vivando®, BASF SE, Germany). Difenoconazole was used as 250 g/L difenoconazole EC (emulsion concentrate) formulation (Bardos Neu®, BASF SE, Germany).

Sphaerotheca fuliginea

| | | | Observed | Calculated | |
|---|---|---|---|---|---|
| | | | effect | effect | |
| | | | 35 days | under | |
| | Dose | | after first | Colby | Synergism |
| Treatment | (g ai/ha) | Mixture | treatment | (%) | (%) |
| Untreated | 93% | — | | | |
| control | infestation | | | | |
| Metrafenone | 100 | — | 70 | | |
| Metrafenone | 50 | — | 46 | | |
| Difenoconazole | 30 | — | 19 | | |
| Metrafenone + | 50 | 1.6:1 | 65 | 56 | 9 |
| difenoconazole | 30 | | | | |
| Metrafenone + | 100 | 3.3:1 | 90 | 76 | 14 |
| difenoconazole | 30 | | | | |

1-15. (canceled)

16. A composition comprising as active components:
active compound 1) 3′-bromo-2,3,4,6′-tetramethoxy-2′,6-dimethylbenzophenone; and
active compound 2) selected from the group consisting of
2a) 2-(2,4-dichlorophenyl)-1-(1H-[1,2,4]triazol-1-yl)hexan-2-ol;
2b) 1-[[4-bromo-2-(2,4-dichlorophenyl)tetrahydro-2-furanyl]methyl]-1H-1,2,4-triazole; and
2c) 1-{2-[2-chloro-4-(4-chlorophenoxy)phenyl]-4-methyl-[1,3]dioxolan-2-yl-methyl}-1H-[1,2,4]triazole;
in a synergistically effective amount.

17. The composition according to claim 16, comprising active compound 1) and active compound 2) in a weight ratio of from 100:1 to 1:100.

18. The composition according to claim 16, in which the active compound 2) is 2-(2,4-dichlorophenyl)-1-[1,2,4]triazol-1-ylhexan-2-ol (active compound 2a).

19. The composition according to claim 16, in which the active compound 2) is 1-[[4-bromo-2-(2,4-dichlorophenyl)tetrahydro-2-furanyl]methyl]-1H-1,2,4-triazole (active compound 2b).

20. The composition according to claim 16, in which the active compound 2) is 1-{2-[2-chloro-4-(4-chlorophenoxy)phenyl]-4-methyl-[1,3]dioxolan-2-ylmethyl}-1H-[1,2,4]triazole (active compound 2c).

21. An agrochemical composition, comprising a solvent or solid carrier and a composition according to claim 16.

22. A method of controlling phytopathogenic harmful fungi wherein the fungi, their habitat or the plants, the soil or seed to be protected against fungal attack are/is treated with a synergistically effective amount of the composition of claim 16.

23. The method according to claim 22, wherein the active compounds 1) and 2) are applied simultaneously jointly, simultaneously separately or in succession.

24. The method according to claim 22, wherein crops of soybeans, rice or cereals are treated with the composition.

25. The method according to claim 22, wherein crops of grapevines, fruit or vegetables are treated with the composition.

26. The method according to claim 22, wherein cucurbits, cucumbers, beans, pomaceous fruit, strawberries or cherries are treated with the composition.

27. The method according to claim 22, wherein the active compounds 1) and 2) are applied in an amount from 5 g/ha to 2000 g/ha.

28. The method according to claim 22, wherein the active compounds 1) and 2) are applied in an amount of from 1 to 1000 g/100 kg of seed.

29. A seed comprising a composition according to claim 16 in an amount of from 1 to 1000 g of active ingredients per 100 kg of the seed.
